(19) United States
(12) Patent Application Publication
(10) Pub. No.: US 2008/0093392 A1
(43) Pub. Date: Apr. 24, 2008

(54) Nozzle Arrangement Comprising a Swirl Chamber

(75) Inventor: Hassan Abduljalil, Manchester (GB)

Correspondence Address: PEARSON & PEARSON, LLP, 10 GEORGE STREET, LOWELL, MA, 01852, US

(73) Assignee: Incro Limited, Stourbridge, West Midlands (GB)

(21) Appl. No.: 11/791,573

(22) PCT Filed: Nov. 17, 2005
(86) PCT No.: PCT/GB05/04415

§ 371 Date: Oct. 19, 2007

(30) Foreign Application Priority Data
Dec. 1, 2004 (GB) 0426429.7

(51) Int. Cl. B05B 1/34; B05B 7/00

(52) U.S. Cl. 222/394; 239/433

(57) ABSTRACT

A nozzle arrangement has a swirl chamber (310) with at least one fluid inlet (312, 314). The inlet is configured to direct fluid into the chamber non-tangentially to the surface of the chamber. Where there are two or more inlets, one of the inlets may have a larger cross-sectional area than the other. Also disclosed are nozzle arrangements having swirl chambers in which the inlets are arranged counter-tangentially, and nozzle arrangements having a swirl chamber whose surface curves longitudinally of the chamber as well as laterally.

The present invention relates to a nozzle arrangement. More particularly, but not exclusively, the present invention relates to a nozzle arrangement for use in generating a spray of a fluid, which is forced to flow through the nozzle arrangement under pressure. The present invention also relates to a dispenser incorporating such a nozzle arrangement.

Nozzles are often used to provide a means of generating sprays of various fluids. In particular, nozzles are commonly incorporated into an actuator fitted to the outlet valves of pressurised fluid-filled containers, such as so-called “aerosol canisters”, to provide a means by which the fluid stored in the container can be dispensed in the form of an atomized spray or mist. A large number of commercial products are presented to consumers in this form, including, for example, antiperspirant sprays, de-odorant sprays, perfumes, air fresheners, antiseptics, paints, insecticides, polish, hair care products, pharmaceuticals, water and lubricants. In addition, pump or trigger-actuated nozzle arrangements, i.e. arrangements where the release of fluid from a non-pressurised container is achieved by the operation of a manually operable pump or trigger that forms an integral part of the arrangement, are also frequently used to generate an atomized spray or mist of certain fluid products. Examples of products that are typically dispensed using pump or trigger nozzle devices include various lotions and insecticides, as well as various garden and household sprays.

Whilst nozzles for aerosol canisters are usually incorporated into an actuator which is located at the end of a stem that extends from the aerosol valve, it has also been proposed to incorporate many of the features of a nozzle directly in the aerosol valve itself and/or in the stem. Accordingly, it should be understood that references to nozzle arrangements herein are intended to cover nozzle arrangements that are incorporated into an aerosol outlet valve or stem as well as nozzle arrangements that form part of a separate component mounted to the stem of an aerosol canister outlet valve or which are part of a manually operable pump or trigger.

Nozzle arrangements are also used in a variety of industrial applications where it is necessary to generate a spray of fluid. For example, misting nozzles are used in horticultural and cooling applications. Nozzle arrangements are also often used as part of a fuel injection system for engines and the like.

A spray is generated when a fluid is caused to flow through a nozzle arrangement under pressure. To form a spray, the nozzle arrangement is configured to cause the fluid stream passing through the nozzle to break up or “atomize” into numerous droplets as it is ejected through one or more outlet orifices.

The optimum size of the droplets required in a spray depends primarily on the particular product concerned and the application for which it is intended. For example, a pharmaceutical spray that contains a drug intended to be inhaled by a patient (e.g. an asthmatic patient) usually requires very small droplets, which can penetrate deep into the lungs. In contrast, a polish spray preferably comprises spray droplets with larger diameters to promote the impaction of the aerosol droplets on the surface that is to be polished and, particularly if the spray is toxic, to reduce the extent of inhalation.

The size of the aerosol droplets produced by conventional nozzle arrangements is dictated by a number of factors, including the dimensions of the outlet orifice and the pressure with which the fluid is forced through the nozzle. However, problems can arise if it is desired to produce a spray that comprises small droplets with a narrow droplet size distribution, particularly at low pressures. The use of low pressures for generating sprays is becoming increasingly desirable because it enables low pressure nozzle devices, such as the manually-operable pump or trigger sprays, to be used instead of more expensive pressurised containers and, in the case of the pressurised fluid-filled containers, it enables the quantity of propellant present in the spray to be reduced, or alternative propellants which typically produce lower pressures (e.g. compressed gas) to be used. The desire to reduce the level of propellant used in aerosol canisters is a topical issue at the moment and is likely to become more important in the future due to legislation planned in certain countries, which proposes to impose restrictions on the amount of propellant that can be used in hand-held aerosol canisters. The reduction in the level of propellant causes a reduction in the pressure available to drive the fluid through the nozzle arrangement and also results in less propellant being present in the mixture to assist with the droplet break up. Therefore, there is a requirement for a nozzle arrangement that is capable of producing an aerosol spray composed of suitably small droplets at low pressures.

A further problem with known pressurised aerosol canisters fitted with conventional nozzle arrangements is that the size of the aerosol droplets generated tends to increase during the lifetime of the aerosol canister, particularly towards the end of the canister's life as the pressure within the canister reduces as the propellant becomes gradually depleted. This reduction in pressure causes an observable increase in the size of the aerosol droplets generated and thus, the quality of the spray produced is compromised.

The problem of providing a high quality spray at low pressures is further exacerbated if the fluid concerned has a high viscosity because it becomes harder to atomize the fluid into sufficiently small droplets.

Various proposals have been made to improve nozzle arrangements in order to overcome, or at least reduce, the problems outline above.

For example, it is known to incorporate a swirl chamber into a nozzle arrangement in which the fluid is caused to spin before exiting the chamber through an outlet orifice. Known swirl chambers typically comprise a cylindrical chamber with an outlet orifice located centrally in a downstream or forward end wall of the chamber. One or more fluid inlets are provided in the side of the chamber which direct the fluid tangentially on to the cylindrical wall so that the fluid spins in the chamber. Where there is more than one inlet orifice, all the inlet orifices feed the fluid into the chamber in the same circumferential direction. Swirl chambers are particularly useful in producing a conical spray pattern from the outlet orifice.

The terms “downstream end” and “upstream end” are used herein with respect to a swirl chamber to refer to the ends of the chamber in the general direction of travel of the fluid through the chamber. Thus the “downstream” end will be the end through which the fluid exits the chamber and in which the outlet is formed whilst the “upstream” end is the end opposite from the downstream end.

A typical known swirl chamber is described in U.S. Pat. No. 6,367,711 B1 to Benoist. In this arrangement, four profiles are arranged in a circle to define a cylindrical chamber in the middle of the profiles. Spaces between adjacent profiles form inlets that direct the fluid tangentially into the central chamber so that the fluid is imparted with a swirling motion. A spray orifice is provided centrally in a downstream end wall of the chamber.

As disclosed in the applicant's International patent application WO 01/89958, it has also been found beneficial to incorporate a swirl chamber in a nozzle arrangement but spaced upstream from the final outlet orifice, as a means of controlling the droplet size and droplet size distribution in the final aerosol.

Many known swirl chambers generate a central core of air about which the fluid, typically a liquor, spins as it exits the outlet orifice. The air core is generated as a result of the liquor forming a vortex as it spins in the chamber which draws the core of air in from outside of the nozzle through the centre of the outlet orifice. Swirl chambers which form a core of air will give rise to a hollow cone shaped spray and can only be used adjacent the final outlet spray orifice of the nozzle.

Although conventional swirl chambers have been found to be effective, there is a need to provide a nozzle arrangement having an alternative swirl chamber configuration that can be used to further enhance the quality of spray produced or to produce a spray with characteristics that are different from those produced using a conventional swirl chamber.

In accordance with a first aspect of the invention, there is provided a nozzle arrangement comprising a swirl chamber having at least one curved surface region, at least one outlet orifice in a downstream end of the chamber though which fluid can exit the chamber and at least one fluid inlet, said at least one inlet being configured to direct fluid into the chamber non-tangentially along a path that extends from the inlet across at least part of the chamber before contacting a surface region of the of the chamber opposite the inlet, the arrangement being such that, in use, the fluid entering the chamber is caused to spin within the chamber before exiting the chamber through the at least one outlet orifice.

There may be two or more inlets configured to direct fluid into the chamber non-tangentially to the surface of the chamber immediately adjacent the respective inlet. The two or more inlets may be configured to direct fluid into the chamber along paths that do not cross within the chamber. The two or more inlets may be configured to direct fluid into the chamber along substantially parallel paths. At least one of said two or more inlets may have a larger cross-sectional area than at least one other of said two or more inlets.

The at least one non-tangential inlet may be configured such that, in use, fluid is directed onto a region of the surface of the chamber that is curved.

The chamber may have a cylindrical surface portion and the at least one inlet may be configured to direct fluid onto the cylindrical surface portion.

There may be two or more inlets arranged in a common plane substantially perpendicular to the longitudinal axis of the chamber.

Two of said two or more inlets may be configured to direct fluid into the chamber from opposite sides thereof so that the fluid streams from the two inlets are caused to rotate about the chamber in substantially the same circumferential direction of the chamber. Alternatively, two of said two or more inlets may be configured to direct fluid into the chamber from the same side thereof so that the fluid steams from the two inlets are caused to rotate about the chamber in generally opposing circumferential directions of the chamber.

There may be at least one further inlet in an upstream end of the chamber.

At least part of the surface of the chamber may be curved both laterally and longitudinally of the chamber. At least part of the surface of the chamber may be dome-like, generally spherical or generally part-spherical.

In accordance with a second aspect of the invention, there is provided a nozzle arrangement comprising a swirl chamber having at least one outlet orifice in a downstream end of the chamber though which fluid can exit the chamber and at least one fluid inlet, in which at least part of the surface of the chamber curves both laterally and longitudinally of the chamber.

The surface of the chamber may include at least one region which is generally dome-like or part-spherical, particularly at an upstream end of the chamber.

The chamber may further comprise a downstream portion having a generally dome-like or part-spherical surface region. The generally dome-like or part-spherical surface region of the upstream portion may have a larger radius than the generally dome-like or part-spherical surface region of the downstream portion.

The generally dome-like or part-spherical surface region of the upstream portion may be separated from the generally dome-like or part-spherical surface region of the downstream portion by an intermediate portion of the chamber.

The chamber may be generally spherical.

The chamber may have a downstream portion having a generally conical surface region.

The chamber may have a plurality of outlet orifices, each outlet orifice being located within a separate generally part-spherical or dome-like surface region of the chamber. Each outlet orifice may be positioned on the polar axis of its respective part-spherical or dome-like surface region.

The chamber may have a surface region which is in the form of a toroidal section, which may be located in a downstream portion of the chamber about the at least one outlet orifice. A generally part-spherical or dome-like surface region of the chamber may be located within the toroidal section surface region.

The at least one inlet may be provided in an upstream end region of the chamber. The at least one inlet may be configured to direct fluid into the chamber along a path which extends longitudinally of the chamber. There may be two or more inlets, each inlet being provided in an upstream end region of the chamber.

The, or each, inlet may be configured to direct fluid into the chamber non-tangentially to the surface of the chamber immediately adjacent the inlet, the arrangement being such that the fluid entering the chamber is directed from the inlet across at least part of the chamber before contacting the surface of the chamber.

The chamber may have two or more inlets, the chamber being configured so that the fluid streams from at least two of said inlets are caused to spin within the chamber in generally opposing circumferential directions.

There may be four or more inlets.

In accordance with a third aspect of the invention, there is provided a nozzle arrangement comprising a swirl chamber having at least one outlet orifice in a downstream end of the chamber though which fluid can exit the chamber and at least two fluid inlets, said at least two inlets each being configured to direct fluid tangentially onto to the surface of the chamber immediately adjacent the respective inlet, in which, at least two of the inlets are arranged such that, in use, they direct streams of fluid in to the chamber such that the fluid streams are caused to rotate in generally opposing circumferential directions of the chamber.

The at least two inlets may enter the chamber from the same side thereof.

The at least two inlets may be provided on a common plane perpendicular to the longitudinal axis of the chamber.

One of said inlets may have a larger cross-sectional area than at least one other of the inlets.

There may be more than two inlets, in which case, at least two of the inlets are arranged such that, in use, they direct streams of fluid in to the chamber such that the fluid streams are caused to rotate in generally opposing circumferential directions of the chamber.

A plurality of inlets may be provided in a number of different planes perpendicular to the longitudinal axis of the chamber so as to be spaced along the length of the chamber. There may be at least two inlets in each of the different planes that are arranged such that, in use, they direct streams of fluid in to the chamber such that the fluid streams are caused to rotate in generally opposing circumferential directions of the chamber.

In accordance with a fourth aspect of the invention, there is provided a nozzle arrangement comprising a swirl chamber having at least one outlet orifice in a downstream end of the chamber though which fluid can exit the chamber and at least two fluid inlets, in which, at least one of the fluid inlets has a larger cross sectional area than at least one other of the fluid inlets. A nozzle in accordance with this fourth aspect of the invention may include any of the features of the first, second and third aspects of the invention.

In the various aspects of the invention, the swirl chamber may have a single outlet orifice arranged centrally in a downstream end of the chamber. Alternatively, the swirl chamber may have a plurality of outlet orifices. The, or each, outlet orifice of the swirl chamber may be a final spray orifice of the nozzle arrangement. Alternatively, the, or each, outlet orifice of the swirl chamber may direct fluid exiting the chamber into a continuation of the nozzle arrangement upstream from the final outlet orifice or orifices of the nozzle arrangement.

Where the swirl chamber has more than one inlet, all the inlets may be arranged to feed the same liquor into the chamber from a fluid source. Alternatively, at least one of the inlets may be arranged to feed a first liquor into the chamber from a first fluid source and at least one other inlet may be arranged to feed a different fluid into the chamber from a second fluid source. The different fluid may be a gas.

In the various aspects of the invention, the nozzle arrangement may have two or more swirl chambers arranged either in parallel or in series with each other. There may be two swirl chambers arranged in series with an expansion chamber arranged in the flow path between the two swirl chambers.

In the various aspects of the invention, the fluid exiting the nozzle arrangement through the, or each, outlet orifice may form anatomized spray having a full cone without a central core of air.

In accordance with a fifth aspect of the invention, there is provided a dispenser comprising a nozzle arrangement according to any one of the previous aspects of the invention.

Several embodiments of the invention will now be described, by of example only, with reference to the accompanying drawings, in which:

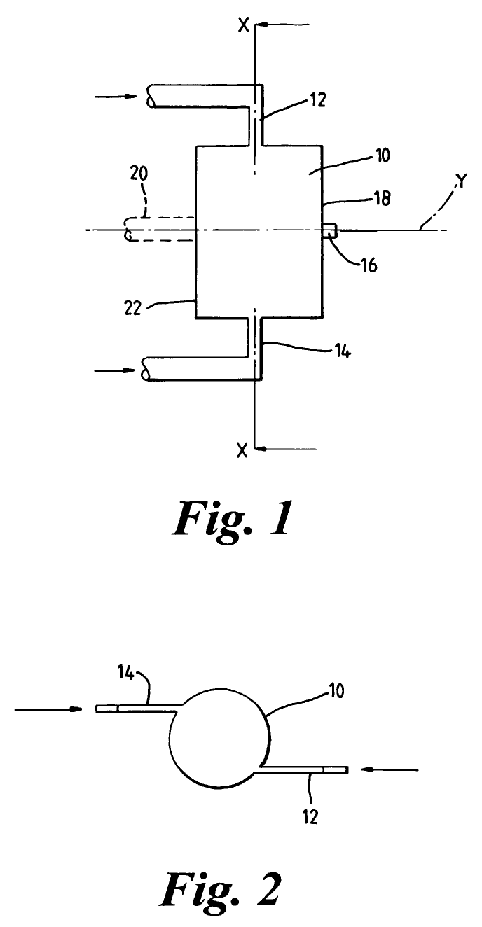

FIG. 1 is a schematic cross-sectional view through a swirl chamber forming part of a nozzle arrangement in accordance with the present invention, the view is taken through a plane that includes the longitudinal axis Y of the chamber;

FIG. 2 is a schematic cross-sectional view taken on line X-X of FIG. 1;

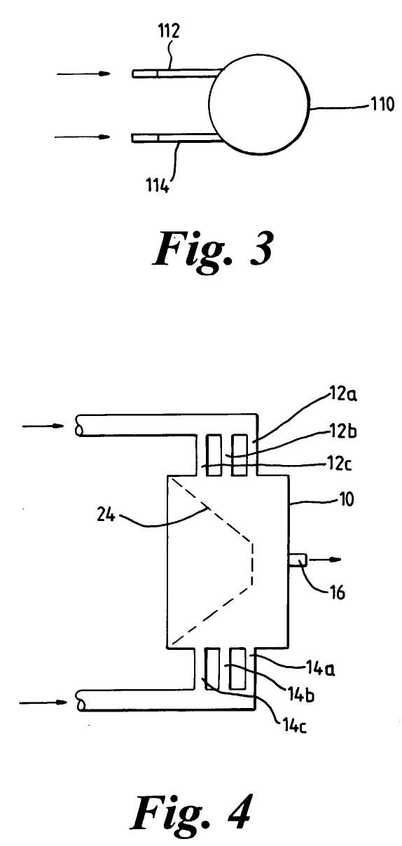

FIG. 3 is a view similar to that of FIG. 2 but showing an alternative embodiment of the chamber in which two inlet orifices enter the chamber from the same side;

FIG. 4 is a view similar to that of FIG. 1, but showing a further alternative embodiment in which multiple inlet orifices are provided on either side of the chamber;

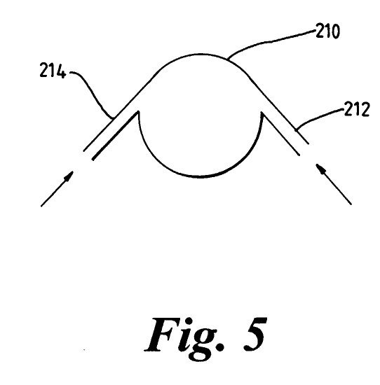

FIG. 5 is a view similar to that of FIG. 2 but showing a yet further alternative embodiment in which two inlet orifices are arranged to direct fluid into the chamber counter-tangentially;

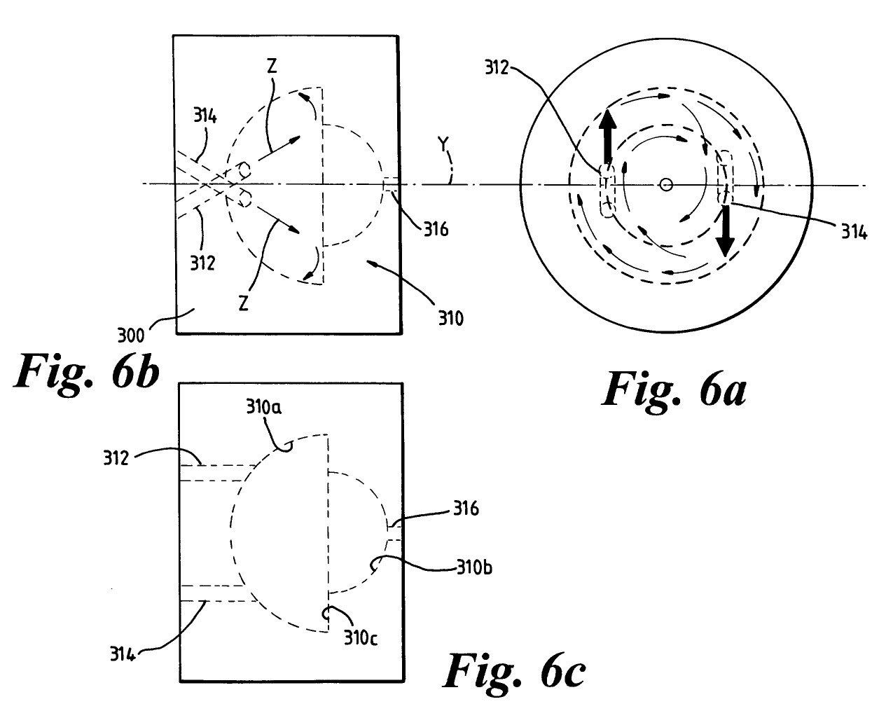

FIGS. 6a, 6b and 6c are schematic front, side and plan elevations respectively of part of a nozzle arrangement in accordance with a further embodiment of the invention, in which details of a swirl chamber are shown in hidden detail by the dashed lines;

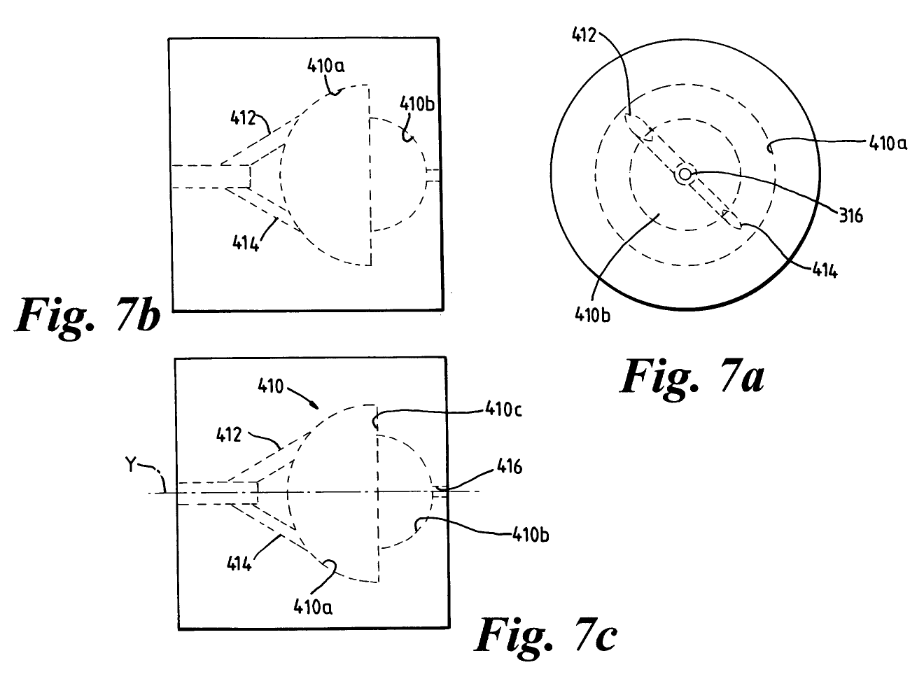

FIGS. 7a, 7b and 7c are views similar to those of FIGS. 6a, 6b and 6c respectively but showing a yet further embodiment of the invention;

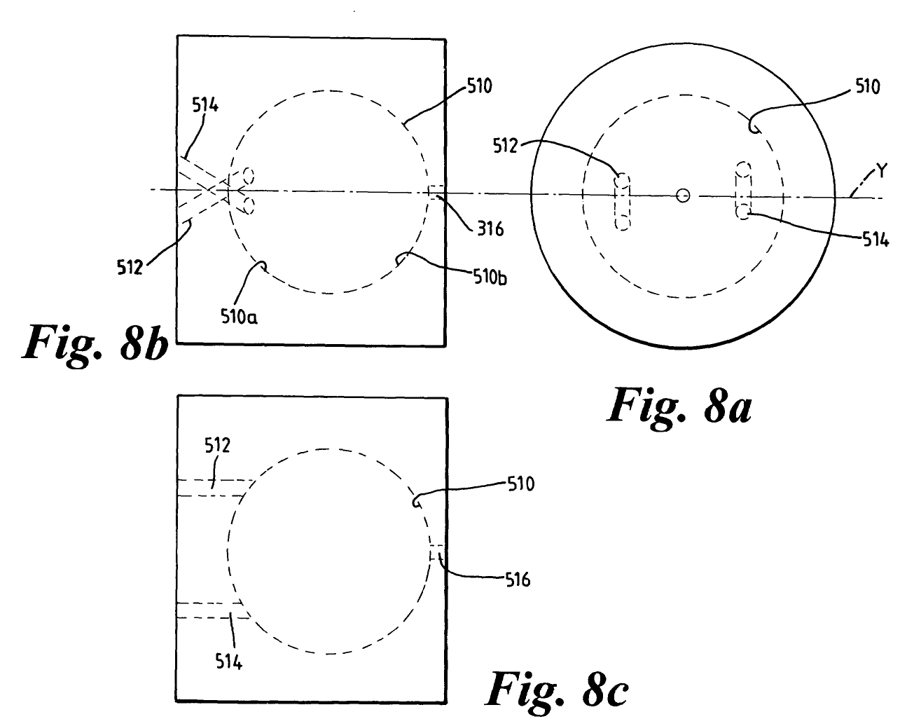

FIGS. 8a, 8b and 8c are views similar to those of FIGS. 6a, 6b and 6c respectively but showing a yet further embodiment of the invention;

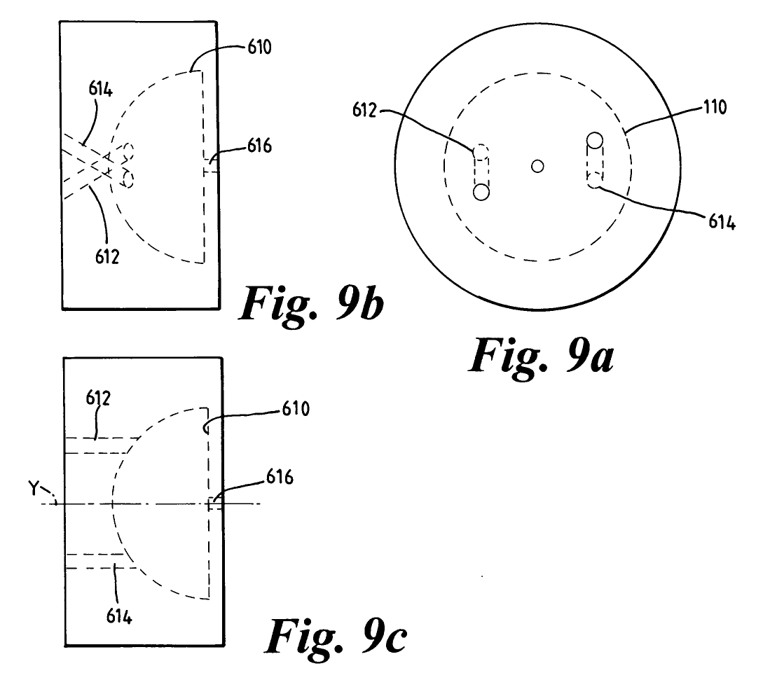

FIGS. 9a, 9b and 9c are views similar to those of FIGS. 6a, 6b and 6c respectively but showing a yet further embodiment of the invention;

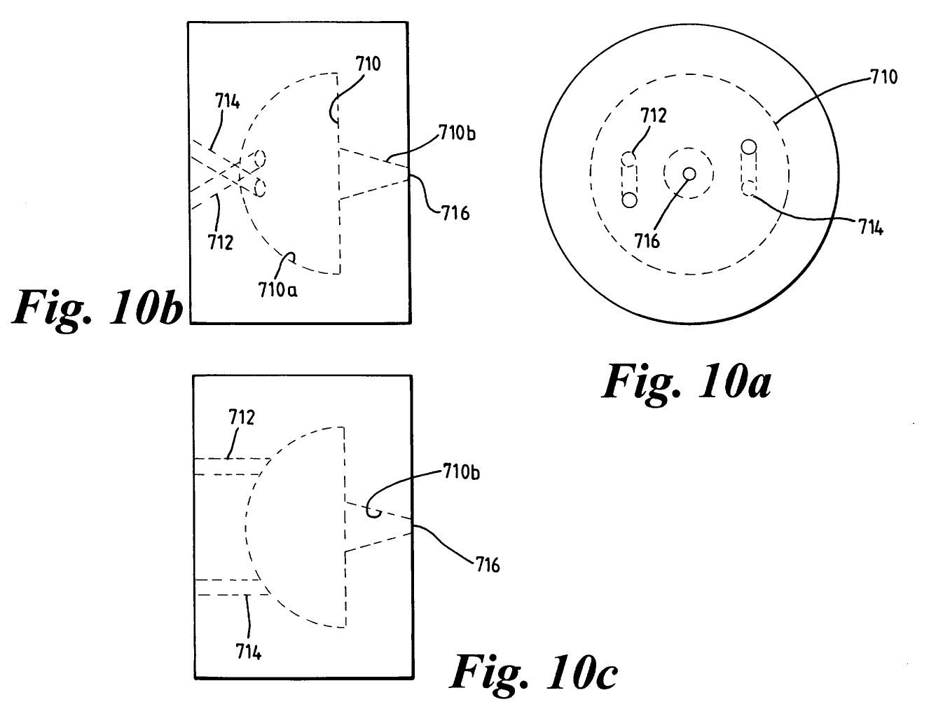

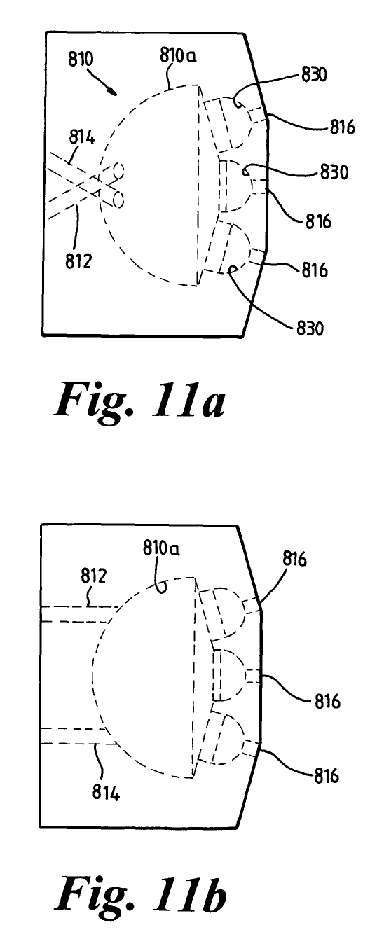

FIGS. 10a, 10b and 10c are views similar to those of FIGS. 6a, 6b and 6c respectively but showing a yet further embodiment of the invention;

FIGS. 11a and 11b are views similar to those of FIGS. 6b and 6c respectively but showing a yet further embodiment of the invention;

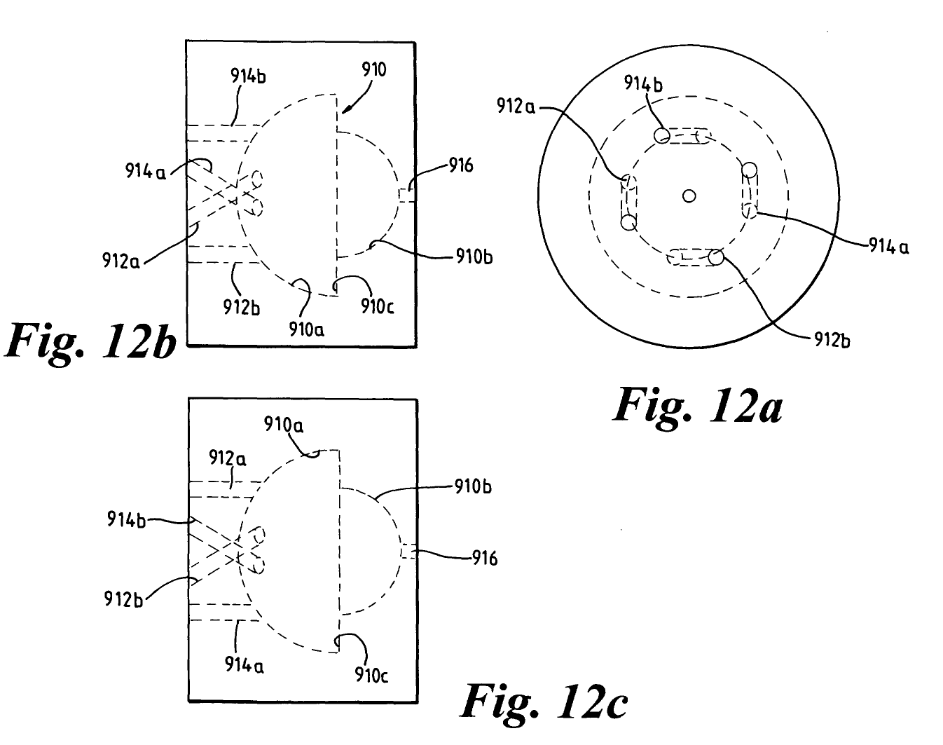

FIGS. 12a, 12b and 12c are views similar to those of FIGS. 6a, 6b and 6c respectively but showing a yet further embodiment of the invention;

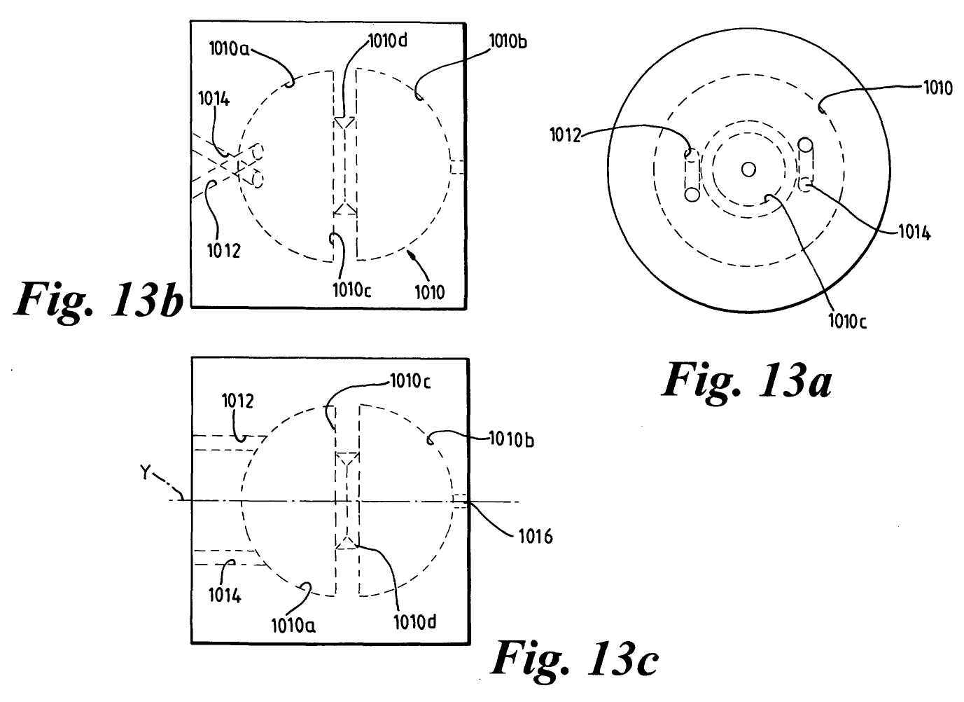

FIGS. 13a, 13b and 13c are views similar to those of FIGS. 6a, 6b and 6c respectively but showing a yet further embodiment of the invention; and

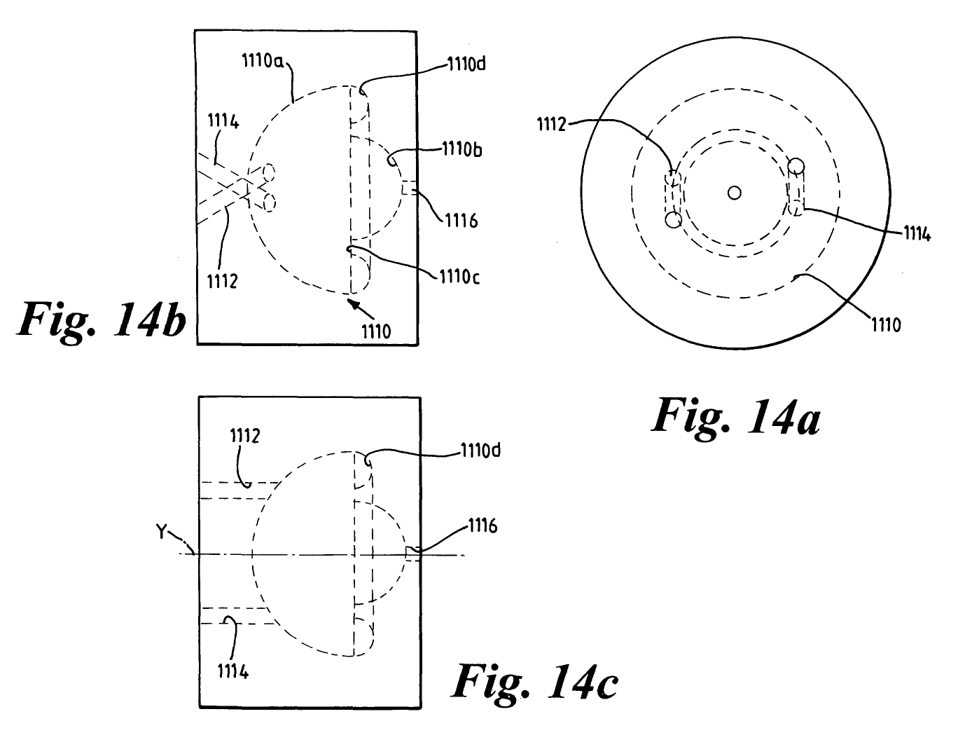

FIGS. 14a, 14b and 14c are views similar to those of FIGS. 6a, 6b and 6c respectively but showing a yet further embodiment of the invention.

With reference initially to FIGS. 1 and 2, there is shown schematically a chamber 10 for use in a nozzle arrangement in accordance with the invention. As with all the embodiments described herein, the chamber 10 may be incorporated into any nozzle arrangement that is adapted to dispense fluid from a fluid source, particularly in the form of a spray. For example, the nozzle arrangement may be incorporated into an actuator or other component fitted to the outlet valve of an aerosol canister. Alternatively, the chamber may be incorporated into the outlet valve itself or into a stem projecting from the outlet valve. The chamber may also be incorporated into a nozzle arrangement of a manual pump or trigger dispenser adapted to spray a fluid from a non-pressurised container. The chamber may also from part of an industrial nozzle or a fuel injection nozzle.

The chamber 10 is cylindrical in shape having a circular cross-section as shown in FIG. 2. Fluid is fed into the chamber 10 through two lateral inlets 12, 14 that enter the chamber from opposite sides. An outlet 16 is located centrally in a wall 18 that defines a downstream end of the chamber 10.

As with all the embodiments disclosed herein, the outlet 16 may be a final spray outlet orifice of the nozzle arrangement or it may direct fluid exiting the chamber into a further part of a flow passage in the nozzle arrangement leading to an outlet orifice or orifices or into a further chamber. The outlet 16 need not be positioned centrally in the downstream end wall of the chamber but can be positioned at any suitable location in the chamber. In certain applications, more than one outlet 16 may be provided.

As can be seen best from FIG. 2, the lateral inlets 12, 14 are offset relative to one another and are arranged to direct the fluid into the chamber in a direction that is not tangential to the wall of the chamber immediately adjacent the inlets and which does not cause the two fluid streams to cross before they contact an opposing wall portion of the chamber. This results in the fluid streams being directed across the chamber towards the opposing wall portion which is curved. When the fluid streams hit the opposing wall portions, some of the fluid will bounce off the wall and some will be caused to rotate within the chamber due to the curvature of the wall portion to impart a swirling motion to the fluid. With the lateral inlets 12, 14 arranged as shown in FIG. 2, the fluid streams will tend to rotate about the chamber in the same circumferential direction, which will be clockwise in the arrangement as shown.

This arrangement is different from a conventional swirl chamber where the inlets direct the fluid tangentially onto the inner wall surface of the chamber so as to move circumferentially about the chamber. Inlets which direct fluid into a swirl chamber in a direction that is not tangential to the surface of the wall through which the inlet enters can be referred to generally as non-tangential inlets.

The applicant has found that swirl chambers having non-tangential inlets produce a spray having finer droplets and with a fuller and wider cone than an equivalent conventional swirl chamber. It is believed to be an advantage of using non-tangential inlets in a swirl chamber that the fluid entering the chamber is not subjected the same level of friction as the fluid in a conventional swirl which is directed immediately onto the wall of the chamber adjacent the inlets. Thus, using non-tangential inlets reduces energy losses in the fluid which enables the swirl to produce a good spray pattern even at low operating pressures as there is more energy in the fluid to assist in the break-up or atomization of the fluid. This also enables the nozzle to be used effectively with solutions that are otherwise difficult to atomize, for example due to their viscosity.

In general, it has been observed that the further the inlet streams are from the surface of the swirl chamber wall, the better the spray characteristics of the nozzle. However, the streams should not overlap with the outlet orifice and should not impinge on each other.

In order to impart a rotary motion to the fluid in the chamber, it is advantageous that the surface of the chamber to which the fluid streams are directed is curved. In the present embodiment, the chamber 10 has a circular cross-section, however, this is not essential and chambers having a non-circular cross-section can be used provided the chamber has a curved wall portion or portions against which the fluid steams can be directed.

As shown in FIGS. 1 and 2, the lateral inlets 12, 14 are the same size but in certain applications it has been found to be advantageous for the inlet on one side to be larger than the inlet on the other side. Using inlets of differing cross-sectional areas produces streams of fluid having different velocities, when the streams mingle in the chamber the difference in velocities is believed to create additional turbulence which is beneficial in helping the break-up of the fluid. As a result, the nozzle produces a spray pattern having smaller droplet sizes particularly towards the end of the spray pulse.

The concept of using different sized inlets is not limited to swirl chambers in accordance with the present embodiment but can be used in respect of all the embodiments disclosed herein as well as with swirl chambers having otherwise conventional tangential inlets.

Although the embodiment shown in FIGS. 1 and 2 has only two lateral inlets 12, 14, more than two lateral inlets can be provided. FIG. 4 shows an embodiment in which there are three lateral inlets 12a, 12b, 12c, 14a, 14b, 14c spaced longitudinally on either side of the chamber. Each of the lateral inlets is arranged to direct fluid into the chamber in a manner similar to the inlets 12, 14 as shown in FIG. 2. The lateral inlets 12a-12c on one side may be larger than the lateral inlets 14a-14c on the other side. Whilst FIG. 4 shows three lateral inlets on either side, it will be appreciated that any suitable number of lateral inlets can be provided. Furthermore, the lateral inlets could be spaced circumferentially, rather than, or in addition to, being spaced longitudinally, provided the streams of fluid do not intersect each other before they contact the opposed curved wall portions of the chamber.

FIG. 3 illustrates a further embodiment of a chamber 110 in which two lateral inlets 112, 114 are arranged to feed fluid into the chamber from the same side of the chamber, so that the fluid travels across the chamber in the same general lateral direction, i.e. both travel from the same side to the chamber towards the opposing side. As with the embodiment shown in FIG. 2, the lateral inlets 112, 114 direct the fluid into the chamber in a direction that is not tangential to the curved lateral wall of the chamber and which does not cause their respective fluid streams to cross. This results in the fluid streams being directed across the chamber towards an opposing curved wall surface. When the fluid streams hit the opposing wall surfaces, some of the fluid will bounce off and some will be caused to rotate within the chamber to impart a swirling motion to the fluid.

Unlike the embodiment shown in FIG. 2 where the fluid streams from the lateral inlets 12, 14 are caused to rotate in the same circumferential direction, in this embodiment the fluid streams from the lateral inlets 112, 114 will be caused to rotate in opposite circumferential directions so as to impact on one another. As the fluid steams contra-rotate about the chamber, one of streams will be forced underneath the other to increase the turbulence and assist in the break up of the fluid into droplets.

As with the previous embodiment, the lateral inlets 112, 114 may be different sizes and more than two inlets can be provided. For example, two or more lateral inlets may be provided longitudinally spaced along the chamber in line with the inlets 112, 114 in a manner similar to that shown in FIG. 4.

In the embodiments shown in FIGS. 2 and 3, the lateral inlets 12, 14; 112, 114 are configured to direct streams of fluid into the chamber 10, 110 substantially parallel to one another. Whilst this is considered to be a particularly advantageous arrangement it is not essential and the lateral inlets may be arranged at an angle to each other provided that the streams of fluid do intersect before they meet the opposing curved portion of the chamber wall.

FIG. 5 illustrates a further embodiment of the invention. As with the embodiment shown in FIG. 2, the chamber 210 has two lateral inlets 212, 214 directing fluid into the chamber from opposite sides. In this embodiment, the lateral inlets 212, 214 are arranged to introduce the fluid tangentially into the chamber so that the fluid contacts the wall of the chamber immediately adjacent the inlets and is caused to rotate in a manner similar to a conventional swirl. However, unlike a conventional swirl where all the inlets direct the fluid into the chamber in the same circumferential direction, the lateral inlets 212, 214 in this embodiment direct the fluid into the chamber 210 in opposite circumferential directions, so that the fluid streams from the lateral inlets 212, 214 contra-rotate about the chamber and collide with each other so that one of the fluid streams is forced underneath the other. This increases the turbulence in the chamber and can lead to finer droplets in the final spray and a fuller cone. One of the lateral inlets 212, 214 may be larger than the other of the inlet orifices 212, 214.

Inlets arranged to direct the fluid into the chamber tangentially but in opposite circumferential directions are referred to herein as being counter-tangential.

As with the previous embodiments, the chamber 210 may have more than two lateral inlets 212, 214, provided that at least two of the lateral inlets are arranged counter-tangentially so as to direct fluid into the chamber in opposite circumferential directions. For example, multiple lateral inlets may be provided on either side of the chamber.

The chamber 210 will have at least one outlet orifice which may be positioned centrally at a downstream end of the chamber in a manner similar to the outlet 16 described above in relation to FIG. 2. The outlet may be a final outlet or spray orifice of the nozzle arrangement or it may direct fluid exiting the chamber into a further part of a flow passage in the nozzle arrangement leading to an outlet orifice or orifices or into a further chamber.

Although chamber 210 is shown as having a circular cross-section, this is not essential. Indeed, in this embodiment is not essential that the walls of the chamber be curved provided that the inlet can direct the fluid tangentially onto the walls so as to impart a rotary or spinning motion to the fluid.

In all the above described embodiments, the lateral inlets 12, 14; 112,114; 212, 214 are shown in pairs on a common plane perpendicular to the longitudinal axis Y of the chamber. However, this is not essential and the lateral inlets can be located on different planes perpendicular to the longitudinal axis.

Furthermore, in all of the embodiments described, one or more additional inlets may enter the chamber 10; 110; 210 from an upstream end. This is illustrated in FIG. 1, which shows in dashed line a single inlet 20 directing fluid longitudinally into the chamber 10 through an upstream end wall 22. Although only one additional inlet is shown in FIG. 1, more than one additional inlet can be provided.

All the lateral inlets may be configured to feed the same fluid into the chamber, which fluid may be liquor or a gas. Alternative, one or more lateral inlets may be configured to feed a first fluid into the chamber and the remaining lateral inlet or inlets a second fluid. The first and second fluids may comprise different liquors or one fluid may be liquor and the other a gas, such as air.

Where the chamber 10; 110; 210 has one or more additional inlets 20, it has been found to be particularly advantageous to direct a gas, such as air, generally longitudinally into the chamber though said one or more additional inlets whilst a liquor is fed into the chamber through the lateral inlets.

In the embodiments described above, the swirl chambers 10; 110; 210 have all had flat upstream and downstream end wall portions. This is not essential and the end portions can be of any suitable shape. In a particular example, one or both ends of the chamber could be tapered to form a conical or frusto-conical shape. Thus, the upstream end of the chamber may taper outwardly from the upstream end to a position part way along the length of the chamber and/or the downstream end of the chamber may taper inwardly from a position part way along the length of the chamber to the downstream end. However, the direction of one or both of the tapers could be reversed. Furthermore, the upstream end of the chamber may have a tapered projection that extends part way into the chamber and about which the fluid in the chamber rotates. This arrangement is illustrated by the dashed lines 24 in FIG. 4.

The previously described embodiments have all comprised cylindrical swirl chambers with a lateral surface which curves (when viewed in lateral cross section) about the longitudinal centre line of the chamber but which extends parallel to the longitudinal centre line along the length of the chamber. It has been found that it can be particularly advantageous to produce a swirl chamber in which at least a part of the surface also curves longitudinally of the chamber to produce a dome-like surface portion. Several embodiments of swirl chambers having one or more dome-like surface regions will now be described with reference to FIGS. 6 to 14.

FIGS. 6a to 6c illustrate schematically part of a further embodiment of a nozzle in accordance with the invention. The nozzle comprises a body 300 and a swirl chamber 310, which is shown in hidden detail by the dashed lines. The swirl chamber 310 has two generally hemispherical surface regions 310a, 310b. A first of the hemispherical surface regions 310a forms the upstream end of the chamber whilst the other hemispherical portion 310b forms the downstream end of the chamber and has a smaller radius than the upstream portion 310a. The chamber also has an annular, flat surface region 310c between the downstream end of the larger hemispherical region 310a and the upstream end of the smaller hemispherical region 310b. An outlet orifice 316 is located on the polar axis of the downstream hemispherical region 310b.

The swirl chamber 310 has two non-tangential inlets 312, 314 in the upstream end of the chamber. The inlets 312, 314 are arranged in different planes one on either side of the chamber and, as shown in FIG. 6b, are angled at approximately 30 degrees to the longitudinal axis Y of the chamber to direct fluid along paths (indicated by the arrows Z in FIG. 6b) that are mutually divergent towards the flat surface portion 310c of the chamber. In use, the fluid streams from the inlets strike the flat wall portion 310c at an angle and the fluid is deflected backwardly and outwardly onto the curved surface of the upstream hemispherical region 310a where it is caused to rotate or spin about the chamber. Because the inlets 312, 314 are angled in opposite directions on either side of the chamber, fluid streams from both inlets are caused to rotate about the chamber 310 in the same circumferential direction as indicted by the arrows in FIG. 6a.

As mentioned above, the inlets 312, 314 are aligned non-tangentially to the surface of the upstream hemispherical region 310a so that the fluid crosses at least part of the chamber before it strikes the flat surface 310c of the chamber. The inlets are configured so that the fluid streams do no intersect before they contact the surface 310c of the chamber and so that they do not cross the centre line of the outlet orifice 316.

In the present embodiment, both of the inlets are the same size but in alternative embodiments one of the inlets could have a larger cross sectional area than the other inlet.

Because the chamber 310 has a dome-like or part spherical surface region 310a, 310b, the inlets 312, 314 can be arranged to enter the chamber through the upstream end and direct the fluid streams into the chamber in a generally longitudinal direction onto a surface of the chamber to cause the fluid to spin or swirl. This is an advantage over a conventional cylindrical swirl chamber in which side passage means are required in order that the inlets can direct fluid into the chamber laterally onto the curved cylindrical surface. Inlets entering through the upstream end of the chamber are generally easier to manufacture and are less likely to block than side channels. Furthermore, without the need for side channels, the swirl chamber 310 takes up less room laterally enabling it to fit in a smaller space. This also enables a number of such swirl chambers to be arranged side by side in close proximity so that the sprays produced by the outlet orifices can be made to overlap or meet.

All the inlets may be arranged to introduce the same liquid or liquor into the chamber 310. Alternatively, one or more inlets can be arranged to introduce a second liquid or even a gas, such as air, into the chamber 310 to mix with the liquor. Where a gas is to be introduced, the gas inlet or inlets can be provided through the upstream end of the chamber or through a side of the chamber.

The number and arrangement of the inlets 312, 314 can be varied as required. Whilst at least two inlets are preferred, a single inlet from the upstream end but directed away from the outlet orifice can be used.

FIGS. 7 to 14 illustrate a number of alternative swirl chamber arrangements that have at least one domed or part-spherical surface region and which can be incorporated into a nozzle arrangement in accordance with the invention.

The chamber 410 shown in FIGS. 7a to 7c is similar to that shown in FIGS. 6a, to 6c described above except that inlets 412, 414 are shown as being split from a single fluid passage. One of the inlets 412 has a larger cross sectional area than the other inlet 414.

FIGS. 8a to 8c illustrate a chamber 510 having spherical surface with a single outlet orifice located on the polar axis of the downstream end of the chamber. The inlets 512, 514 are provided in the upstream end of the chamber and are arranged in a manner similar to that of chamber 310 described above. The inlets direct the fluid into the chamber non-tangentially so as to contact the curved surface of the downstream end of the chamber where it is caused to rotate or spin within the chamber.

In the arrangement shown in FIGS. 9a to 9c, the chamber 610 is hemispherical with the curved surface region being located at the upstream end and with the polar axis in line with the longitudinal axis Y of the chamber. A single outlet orifice 616 is located centrally in the flat downstream end wall of the chamber. Two non-tangential inlets 612, 614 enter through the upstream end of the chamber and direct fluid onto the flat downstream end wall at an angle in a manner similar to that of the chamber 310 described above, so that the fluid is deflected back into the chamber and outwardly onto the curved surface of the chamber where it is caused to spin about the chamber.

FIGS. 10a to 10c show a nozzle arrangement having a swirl chamber 710 which is similar to the chamber 310 described above, except that the downstream region of the chamber has a conical surface region 710b tapering towards an outlet orifice 716.

A nozzle arrangement incorporating a swirl chamber 810 having multiple outlet orifices 816 is shown in FIGS. 11a and 11b. The chamber 810 has an upstream region 810a with a hemispherical surface and three outlet orifices 816 in a downstream region. Each outlet orifice is located at the apex of a respective domed or hemispherical chamber region 830. The chamber has two non-tangential inlets 812, 814 located in the upstream end of the chamber in a manner similar to those of the chamber 310 described above in relation to FIGS. 6a to 6c. In this embodiment, as well as spinning about the main chamber, the fluid is caused to spin about each of the domed regions 830 adjacent the outlet orifices 816.

FIGS. 12a to 12c illustrate a nozzle arrangement having a swirl chamber 910 similar to the chamber 310 described above in relation to FIGS. 6a to 6c. However, in this embodiment, the chamber 910 has four inlets 912a, 912b, 914a, 914b spaced about the upstream end 910a of the chamber. The inlets direct fluid into the chamber non-tangentially so that the fluid streams contact the annular flat surface region 910c and are deflected backwardly and outwardly onto the curved upstream hemispherical surface 910a where they are caused to rotate or spin about the chamber.

The nozzle arrangement shown in FIGS. 13a to 13c has a swirl chamber 1010 with an upstream hemispherical surface region 1010a and a downstream hemispherical surface region 1010b separated by a connecting surface region 1010d. The two hemispherical surface regions 1010a, 1010b are of the same size, whilst the connecting region 1010d has a smaller radius. The connecting region 1010d in this embodiment has a surface which tapers inwardly to a peak at the centre but in alternative embodiments the connecting region could have a cylindrical surface. The chamber 1010 has two non-tangential fluid inlets 1012, 1014 similar to those 312, 314 of the chamber 310 described above in relation to FIGS. 6a to 6c. A single outlet orifice 1016 is provided in the centre of the downstream hemispherical surface region 1010b.

It should be appreciated that the above embodiment can be varied in many ways. For example, the size and shape of the connecting portion 1010d can be varied. Thus the connecting portion could have the same radius as the two hemispherical regions 1010a, 1010b and could be in the form of a cylindrical surface region that separates the two hemispherical regions 1010a, 1010b. Alternatively, the relative sizes of the two hemispherical regions 1010a, 1010b could be varied. Thus the downstream hemispherical region 1010b could be made smaller than the upstream hemispherical portion or vice versa.

The swirl chamber 1110 in the nozzle arrangement shown in FIGS. 14a to 14c is again similar to the swirl chamber 310 described above in relation to FIGS. 6a to 6c, the only difference being that the chamber 1110 in this embodiment has a toroidal section surface region 1110d surrounding the smaller upstream hemispherical surface region 1110b. The toroidal section surface region opens towards the upstream end of the chamber and the inlets 1112, 1114 direct the fluid non-tangentially into the chamber from the upstream end of the chamber so that the fluid streams contact the concave surface of toroidal section surface region 1110d and are caused to rotate or spin about the chamber. The toroidal section 1110d comprises an annular region having a generally U shape in cross section and which surrounds the smaller downstream hemispherical region.

It will be appreciated that the embodiments shown in FIGS. 6 to 14 are only examples of how a dome-like surface region can be incorporated into swirl chamber of a nozzle arrangement. The various embodiments shown can be modified in numerous ways. For example, any of the embodiments shown can be provided with one or more inlets that can be standard tangential inlets, counter-tangential inlets or non-tangential inlets. Furthermore, any of the swirl chambers shown can have more than one outlet orifice.

It should be understood that whilst the surfaces have been described as being part-spherical, hemispherical or spherical, it is not essential that the surfaces are perfectly spherical or part-spherical so long as they encourage the fluid to spin or rotate about the chamber.

In tests, swirl chambers having a dome-like surface region that curves longitudinally of the chamber as well as laterally, have been shown to produce improved spray performances with a full cone and finer droplets than an equivalent conventional swirl chamber under similar operating conditions.

It has been found that chambers in accordance with any of the embodiments described herein can advantageously be made larger than conventional swirl chambers. Known swirl chambers are typically in the region of 1 mm to 2 mm in diameter, whereas chambers in accordance with the invention have been found to be effective at sizes of up to 6 mm in diameter or width. In particular, chambers in accordance with the invention having a diameter/width of 3 mm to 5 mm, and more particularly 4 mm, have been found to produce advantageous results. The chambers may be of any suitable length which typically can be anywhere from 0.3 mm to 10 mm. It is expected that in most applications the chamber will have a length of from 0.5 mm to 3 mm. Chambers having counter-tangential inlets may be shorter having a length of between 0.5 mm to 4 mm with a length of between 0.5 mm to 1.5 mm being preferable.

The swirl chambers which form part of a nozzle in accordance with the invention do not rely on the formation of a core of air at the centre of the swirling liquid. This means that the swirl chamber does not have to be used exclusively adjacent to a final spray orifice of the nozzle arrangement but can be used upstream from the final spray orifice and can even be used in series with at least one another swirl chamber, which may be a conventional swirl chamber or one in accordance with any aspect of the present invention. In one advantageous arrangement two swirl chambers are arranged in series, with an expansion chamber provided in the flow path between them.

Where the swirl chamber is positioned adjacent the final outlet or spray orifice, a nozzle in accordance with the invention will produce a full cone spray pattern rather than a hollow cone even at wide spray cone angles. The nozzle will also produce a spray having smaller droplet sizes and a narrower droplet size distribution than that of a nozzle having a comparable conventional swirl. The spray produced has a parabolic like pattern having a higher axial velocity component than a nozzle with a comparable conventional swirl. As a result, the spray produced by a nozzle in accordance with the invention has a longer penetration distance and the rate of increase in the mean droplet size with distance from the outlet orifice is lower than for conventional swirls.

Nozzle arrangements in accordance with the invention can be used in a wide variety of applications including aerosol or manual pump dispensers and many industrial applications including misting nozzles and fuel injection systems for engines and the like. Nozzle arrangements in accordance with the invention can be adapted for use at operating pressures ranging from 0.5 bars to 250 bars or more and with fluids having any viscosity, including liquors.

In the preferred embodiments described above, the nozzle arrangements are manufactured from polymeric materials using injection moulding techniques, which is particularly suitable for mass production at low cost. However, the invention should be understood to encompass nozzle arrangements made from any suitable materials using any suitable techniques. Typically the nozzles will comprises a body having two parts which fit together to define the swirl chamber. The parts may each have an abutment surface which mates with a corresponding abutment surface on the other part. A series of grooves and/or recess may be formed in at least one of the abutment surfaces to define the swirl chamber when the two parts are assembled. Typically, corresponding grooves and/or recess will be formed in the abutment surfaces of both parts and which between them define the swirl chamber when the parts are assembled.

Whereas the invention has been described in relation to what are currently considered to be the most practicable and preferred embodiments, it should be understood that the invention is not limited to disclosed arrangements but rather is intended to cover various modifications and equivalent constructions included within the scope of the invention.

1-76. (canceled)

77. An atomising nozzle arrangement comprising a swirl chamber having at least one curved surface region, at least one outlet orifice in a downstream end of the chamber through which fluid can exit the chamber and two or more lateral fluid inlets, said two or more lateral inlets each being configured to direct fluid into the chamber non-tangentially along a path that extends from the respective inlet across at least part of the chamber before contacting a surface region of the chamber opposite the inlet, the arrangement being such that, in use, the fluid entering the chamber is caused to spin within the chamber before exiting the chamber through the at least one outlet orifice; characterised in that at least one of said two or more lateral inlets has a larger cross-sectional area than that of least one other of said two or more lateral inlets.

78. An atomising nozzle arrangement as claimed in claim 77, in which at least two of the two or more lateral inlets are configured to direct fluid into the chamber along paths that do not cross within the chamber.

79. An atomising nozzle as claimed in claim 77, in which at least two of the two or more inlets are configured to direct fluid into the chamber along substantially parallel paths.

80. An atomising nozzle arrangement as claimed in claim 77, in which each of the two or more non-tangential inlets is configured such that, in use, fluid is directed onto a region of the surface of the chamber that is curved.

81. An atomising nozzle arrangement as claimed in claim 80, in which the chamber has a cylindrical surface portion and each of the two or more lateral inlets is configured to direct fluid onto the cylindrical surface portion.

82. An atomising nozzle arrangement as claimed in claim 77, in which there are two or more lateral inlets arranged in a common plane substantially perpendicular to the longitudinal axis of the chamber.

83. An atomising nozzle arrangement as claimed in claim 77, in which two of said two or more lateral inlets are configured to direct fluid into the chamber from opposite sides thereof.

84. An atomising nozzle arrangement as claimed in claim 77, in which two of said two or more lateral inlets are configured to direct fluid into the chamber from the same side thereof in contra-rotating directions.

85. An atomising nozzle arrangement as claimed in claim 77 in which there is at least one further inlet in an upstream end of the chamber.

86. An atomising nozzle arrangement as claimed in claim 77, in which at least part of the surface of the chamber is curved both laterally and longitudinally of the chamber.

87. An atomising nozzle arrangement as claimed in claim 86, in which at least part of the surface of the chamber is generally spherical or part spherical.

88. An atomising nozzle arrangement comprising a swirl chamber having at least one outlet orifice in a downstream portion of the chamber through which fluid can exit the chamber and at least one fluid inlet, in which the chamber has an upstream portion opposite the downstream portion in which the surface of the chamber curves both laterally and longitudinally of the chamber, the at least one inlet entering the chamber through the curved upstream portion.

89. An atomising nozzle arrangement as claimed in claim 88, in which the upstream portion of the chamber comprises a generally part-spherical surface region, in which the polar axis of the generally-part spherical surface region is substantially aligned with the longitudinal axis of the chamber.

90. An atomising nozzle arrangement as claimed in claim 89, in which the downstream portion of the chamber has a generally part-spherical surface region.

91. An atomising nozzle arrangement as claimed in claim 90, in which the chamber is generally spherical.

92. An atomising nozzle arrangement as claimed in claim 90, in which the generally part-spherical surface region of the upstream portion has a larger radius than the generally part-spherical surface region of the downstream portion.

93. An atomising nozzle arrangement as claimed in claim 90, in which the generally part-spherical surface region of the upstream portion is separated from the generally part-spherical surface region of the downstream portion by an intermediate portion of the chamber.

94. An atomising nozzle arrangement as claimed in claim 89, in which the downstream portion has a generally conical surface region.

95. An atomising nozzle arrangement as claimed in claim 88, in which the chamber has a plurality of outlet orifices, each outlet orifice being located within a separate generally part-spherical surface region of the chamber.

96. An atomising nozzle arrangement as claimed in claim 95, in which each outlet orifice is positioned on the polar axis of its respective part-spherical surface region.

97. An atomising nozzle arrangement as claimed in any claim 88, in which the chamber also comprises a surface region which is in the form of a toroidal section.

98. An atomising nozzle arrangement as claimed in claim 97, in which the toroidal section surface region is located in the downstream portion of the chamber about the at least one outlet office.

99. An atomising nozzle arrangement as claimed in claim 97, in which a downstream portion of the chamber further comprises a generally part-spherical surface region located within the toroidal section surface region.

100. An atomising nozzle arrangement as claimed in claim 88, in which the at least one inlet is configured to direct fluid into the chamber along a path which extends generally longitudinally of the chamber.

101. An atomising nozzle arrangement as claimed in claim 88, in which there are two or more inlets, each inlet being provided in the upstream portion of the chamber.

102. An atomising nozzle arrangement as claimed in claim 88, in which the, or each, inlet is configured to direct fluid into the chamber non-tangentially to the surface of the chamber immediately adjacent the inlet, the arrangement being such that the fluid entering the chamber is directed from the inlet across at least part of the chamber before contacting the surface of the chamber.

103. An atomising nozzle arrangement as claimed in claim 102, in which the chamber has two or more inlets in the upstream portion, the chamber being configured so that the fluid streams from at least two of said inlets are caused to spin within the chamber in generally opposing circumferential directions.

104. An atomising nozzle arrangement as claimed in claim 88, in which there are four or more inlets in the upstream portion.

105. An atomising nozzle arrangement as claimed in claim 88, in which the chamber has more than one inlet in the upstream portion, at least one of said inlets having a larger cross-sectional area than that of least one other of said inlets.

106. An atomising nozzle arrangement comprising a swirl chamber having at least one outlet orifice in a downstream end of the chamber through which fluid can exit the chamber and two or more lateral fluid inlets, each inlet bring configured to direct fluid tangentially onto to the surface of the chamber immediately adjacent the respective inlet, characterised in that at least two of the inlets are arranged such that, in use, they direct streams of fluid into the chamber such that the fluid streams are caused to rotate in generally opposing circumferential directions of the chamber and that at least one of said inlets has a larger cross-sectional area than at least one other of the inlets.

107. An atomising nozzle arrangement as claimed in claim 106, in which said at least two inlets enter the chamber from the same side thereof.

108. An atomising nozzle arrangement as claimed in claim 106, in which said at least two inlets are provided on a common plane perpendicular to the longitudinal axis of the chamber.

109. An atomising nozzle arrangement as claimed in claim 106, in which there are more than two inlets, at least two of the inlets being arranged such that, in use, they direct streams of fluid in to the chamber such that the fluid streams are caused to rotate in generally opposing circumferential directions of the chamber.

110. An atomising nozzle arrangement as claimed in claim 109, in which a plurality of inlets are provided in a number of different planes perpendicular to the longitudinal axis of the chamber so as to be spaced along the chamber.

111. An atomising nozzle arrangement as claimed in claim 110, in which there are at least two inlets in each of the different planes that are arranged such that, in use, they direct streams of fluid in to the chamber such that the fluid streams are caused to rotate in generally opposing circumferential directions of the chamber.

112. An atomising nozzle arrangement as claimed in claim 77, in which the swirl chamber has a single outlet orifice arranged centrally in a downstream end of the chamber.

113. An atomising nozzle arrangement as claimed in claim 77, in which the swirl chamber has a plurality of outlet orifices.

114. An atomising nozzle arrangement as claimed in claim 77, in which the, or each, outlet orifice of the swirl chamber is a final spray orifice of the nozzle arrangement.

115. An atomising nozzle arrangement as claimed in claim 77, in which the, or each, outlet orifice of the swirl chamber directs fluid exiting the chamber into a continuation of the nozzle arrangement upstream from the final outlet orifice or orifices of the nozzle arrangement

116. An atomising nozzle arrangement as claimed in claim 77, in which the swirl chamber has more than one inlet and all the inlets are arranged to feed the same liquid into the chamber from a fluid source.

117. An atomising nozzle arrangement as claimed in claim 77, in which the swirl chamber has more than one inlet and at least one of the inlets is arranged to feed a liquid into the chamber from a first fluid source and at least one other inlet is arranged to feed a different fluid into the chamber from a second fluid source.

118. An atomising nozzle arrangement as claimed in claim 117, in which the different fluid is a gas.

119. An atomising nozzle as claimed in claim 77, in which at least one of an upstream portion and a downstream portion of the chamber is tapered.

120. An atomising nozzle as claimed in claim 119, in which the at least one of an upstream portion and a downstream portion of the chamber is tapered to form a conical or frusto-conical shape.

121. An atomising nozzle arrangement as claimed in claim 77, the nozzle arrangement comprising two or more swirl chambers arranged in parallel with each other.

122. An atomising nozzle arrangement as claimed in claim 77, the nozzle arrangement comprising two or more swirl chambers arranged in series.

123. An atomising nozzle arrangement as claimed in claim 120, comprising two swirl chambers in series with an expansion chamber arranged in the flow path between the two swirl chambers.

124. An atomising nozzle arrangement as claimed in claim 77, in which the fluid exiting the chamber through the, or each, outlet orifice forms an atomized spray having a full cone without a central core of air.

125. A dispenser comprising an atomising nozzle arrangement according to claim 77.

126. An atomising nozzle arrangement as claimed in claim 94, in which there are two or more inlets, each inlet bring provided in the upstream portion of the chamber.

127. An atomising nozzle arrangement as claimed in claim 97, in which there are two or more inlets, each inlet bring provided in the upstream portion of the chamber.

128. An atomising nozzle arrangement as claimed in claim 94, in which the, or each, inlet is configured to direct fluid into the chamber non-tangentially to the surface of the chamber immediately adjacent the inlet, the arrangement being such that the fluid entering the chamber is directed from the inlet across at least part of the chamber before contacting the surface of the chamber.

129. An atomising nozzle arrangement as claimed in claim 97, in which the, or each, inlet is configured to direct fluid into the chamber non-tangentially to the surface of the chamber immediately adjacent the inlet, the arrangement being such that the fluid entering the chamber is directed from the inlet across at least part of the chamber before contacting the surface of the chamber.

130. An atomising nozzle arrangement as claimed in claim 94, in which there are four or more inlets in the upstream portion.

131. An atomising nozzle arrangement as claimed in claim 97, in which there are four or more inlets in the upstream portion.

132. An atomising nozzle arrangement as claimed in claim 88, in which the swirl chamber has a single outlet orifice arranged centrally in a downstream end of the chamber.

133. An atomising nozzle arrangement as claimed in claim 106, in which the swirl chamber has a single outlet orifice arranged centrally in a downstream end of the chamber.

134. An atomising nozzle arrangement as claimed in claim 88, in which the swirl chamber has a plurality of outlet orifices.

135. An atomising nozzle arrangement as claimed in claim 106, in which the swirl chamber has a plurality of outlet orifices.

136. An atomising nozzle arrangement as claimed in claim 88, in which the, or each, outlet orifice of the swirl chamber is a final spray orifice of the nozzle arrangement.

137. An atomising nozzle arrangement as claimed in claim 106, in which the, or each, outlet orifice of the swirl chamber is a final spray orifice of the nozzle arrangement.

138. An atomising nozzle arrangement as claimed in claim 88, in which the, or each, outlet orifice of the swirl chamber directs fluid exiting the chamber into a continuation of the nozzle arrangement upstream from the final outlet orifice or orifices of the nozzle arrangement

139. An atomising nozzle arrangement as claimed in claim 106, in which the, or each, outlet orifice of the swirl chamber directs fluid exiting the chamber into a continuation of the nozzle arrangement upstream from the final outlet orifice or orifices of the nozzle arrangement.

140. An atomising nozzle arrangement as claimed in claim 88, in which the swirl chamber has more than one inlet and all the inlets are arranged to feed the same liquid into the chamber from a fluid source.

141. An atomising nozzle arrangement as claimed in claim 106, in which the swirl chamber has more than one inlet and all the inlets are arranged to feed the same liquid into the chamber from a fluid source.

142. An atomising nozzle arrangement as claimed in claim 88, in which the swirl chamber has more than one inlet and at least one of the inlets is arranged to feed a liquid into the chamber from a first fluid source and at least one other inlet is arranged to feed a different fluid into the chamber from a second fluid source.

143. An atomising nozzle arrangement as claimed in claim 106, in which the swirl chamber has more than one inlet and at least one of the inlets is arranged to feed a liquid into the chamber from a first fluid source and at least one other inlet is arranged to feed a different fluid into the chamber from a second fluid source.

144. An atomising nozzle as claimed in claim 106, in which at least one of an upstream portion and a downstream portion of the chamber is tapered.

145. An atomising nozzle arrangement as claimed in claim 88, the nozzle arrangement comprising two or more swirl chambers arranged in parallel with each other.

146. An atomising nozzle arrangement as claimed in claim 106, the nozzle arrangement comprising two or more swirl chambers arranged in parallel with each other.

147. An atomising nozzle arrangement as claimed in claim 88, the nozzle arrangement comprising two or more swirl chambers arranged in series.

148. An atomising nozzle arrangement as claimed in claim 106, the nozzle arrangement comprising two or more swirl chambers arranged in series.

149. An atomising nozzle arrangement as claimed in claim 88, in which the fluid exiting the chamber through the, or each, outlet orifice forms an atomized spray having a full cone without a central core of air.

150. An atomising nozzle arrangement as claimed in claim 106, in which the fluid exiting the chamber through the, or each, outlet orifice forms an atomized spray having a full cone without a central core of air.

151. A dispenser comprising an atomising nozzle arrangement according to claim 88.

152. A dispenser comprising an atomising nozzle arrangement according to claim 106.
